(19) United States
(12) Patent Application Publication
(10) Pub. No.: US 2026/0320710 A1
(43) Pub. Date: Oct. 15, 2026

(54) Integrated Real Estate Risk Scoring and Portfolio Analysis

(71) Applicants: Raymond Paul Shivers, III, Mickleton, NJ (US); Madison Hammel, Farmington Hills, MI (US)

(72) Inventors: Raymond Paul Shivers, III, Mickleton, NJ (US); Madison Hammel, Farmington Hills, MI (US)

(21) Appl. No.: 19/546,362

(22) Filed: Feb. 22, 2026

(51) Int. Cl. G06Q 50/163; G06Q 40/03

(52) U.S. Cl. CPC G06Q 50/163; G06Q 40/033

(57) ABSTRACT

A computer-implemented platform calculates a comprehensive risk score for real-estate properties by retrieving and normalizing data for multiple risk factors, weighting those factors according to user-defined preferences, accepting user-editable inputs, and combining the weighted factors to produce an overall risk score. Eleven factors are considered, including crime, property condition, environmental hazards, rent market health, market hotness, school quality, liquidity, landlord-tenant friendliness, vacancy, population growth, and job growth. The system caches external data with appropriate time-to-live periods and updates scores dynamically as inputs change. The risk scores are presented alongside traditional financial assets on a unified dashboard, allowing investors to assess how real-estate holdings affect overall portfolio risk and long-term financial projections.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The invention relates generally to computer-implemented investment analysis and, more particularly, to systems and methods for assessing real-estate investment risk by combining numerous factors and integrating the resulting risk scores with financial portfolio analytics.

### BACKGROUND OF THE INVENTION

Automated real-estate valuation and risk assessment tools typically evaluate a limited set of variables or focus on loan collateral risk. For example, U.S. Patent Application Publication No. US 2004/0153330 A1 evaluates collateral risk quality using factors such as economic conditions, future value risk, and liquidity, and weights them to produce a score. The method does not account for granular factors such as crime, school quality, local rent growth, or landlord-tenant regulations.

Other systems assess portfolio risk based on an investor's tolerance but are concerned only with financial assets. U.S. Pat. No. 5,680,305 describes a score composed of five indicators (amount, price, grade, area, and risk) for evaluating corporate real-estate portfolios. While this score aids business managers, it does not integrate real-estate risk with personal financial assets or provide user-editable weighting across numerous factors.

There remains a need for a system that (i) evaluates real-estate risk using a comprehensive set of factors sourced from multiple databases; (ii) allows users to tailor factor weights and inputs to reflect individual circumstances; (iii) caches data intelligently to balance timeliness and efficiency; and (iv) integrates the resulting risk scores with broader portfolio analysis to inform investment decisions. The present invention addresses these needs.

### BRIEF SUMMARY OF THE INVENTION

Disclosed is a computer-implemented platform that calculates a comprehensive risk score for real-estate properties by retrieving and normalizing data for multiple risk factors, weighting those factors according to user-defined preferences, accepting user-editable inputs, and combining the weighted factors to produce an overall risk score. Eleven factors are considered in the preferred embodiment, including crime, property condition, environmental hazards, rent market health, market hotness, school quality, liquidity, landlord-tenant friendliness, vacancy, population growth, and job growth. The system caches external data with appropriate time-to-live periods and updates scores dynamically as inputs change.

The risk scores are presented alongside traditional financial assets on a unified dashboard, allowing investors to assess how real-estate holdings affect overall portfolio risk and long-term financial projections. The invention provides a novel combination of broad factor coverage, user customization, and portfolio integration not found in prior real-estate scoring or financial portfolio management systems.

In one aspect, the invention provides a platform comprising client and server components that cooperatively compute a multi-factor risk score for an individual property and aggregate such scores across a portfolio. Upon receiving a property identifier (e.g., address) from the user interface, the system retrieves data from external providers for each of the eleven risk factors. It normalizes the raw data into scores within a common range (e.g., 0-100 or 0-10), applies a weight to each score, incorporates user-editable inputs for certain factors, and sums the weighted scores to produce an overall risk value. The weights may be default values or adjusted by the user through the interface.

The external data sources include: crime statistics from government databases; census data for population and vacancy; natural hazard indices from FEMA; rental market data (median rent, rent growth, days on market); school district rankings; market hotness measures (inventory and buyer demand); address verification services; financial account balances; and artificial intelligence to map CSV uploads. Each data source is proxied through an internal API, and the retrieved data are cached in a database with a time-to-live appropriate to the volatility of the underlying metric. For example, market hotness and rent metrics are refreshed daily or weekly, whereas crime and school ratings are cached for months.

The system displays the overall risk score and its constituent factors in an interactive user interface, allows the user to expand any factor to view details, and permits the user to adjust inputs such as property condition or landlord-tenant friendliness. The risk scores feed into a broader dashboard that also shows financial accounts, aggregate cash flows, net worth projections, and financial independence (FIRE) modelling. Thus, the invention enables investors to understand how real-estate risk interacts with their overall financial plan and to perform scenario analyses.

### BRIEF DESCRIPTION OF THE DRAWINGS

The accompanying figures illustrate example embodiments of the invention and form part of the specification.

FIG. 1A is a high-level block diagram of the system architecture, showing the user input layer, the validation and resolution layer, the calculation engine, the data access layer, and the storage layer of the system, together with the flow of data among these layers.

FIG. 1B is a module-level diagram of the same system architecture as FIG. 1A, identifying the principal computational engines (Property Calculator, FIRE Projection Engine, and Forecasting Engines) and the data access and storage components that cooperate to produce the risk scores.

FIG. 2 shows the user interface for adding a property, where the user provides address, purchase price, year built, and condition, and initiates the risk analysis.

FIG. 3 illustrates a properties dashboard displaying multiple properties with horizontal bars indicating their overall risk scores.

FIG. 4 presents a detailed property view containing expandable cards for each risk factor, enabling the user to see the source data and computed scores.

FIG. 5 is a flow diagram of the risk scoring algorithm, illustrating retrieval of external data, normalization of scores, application of weights, summation of weighted scores, caching, and display.

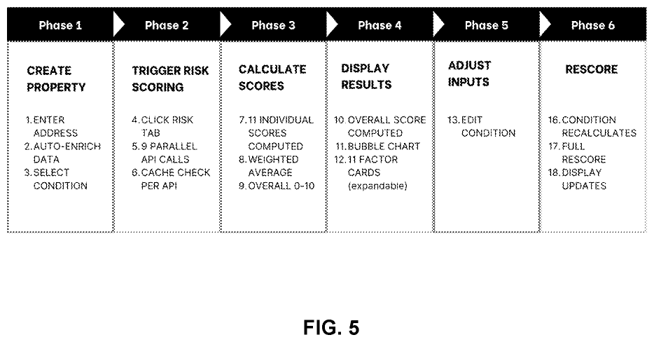

### DETAILED DESCRIPTION OF THE PREFERRED EMBODIMENTS

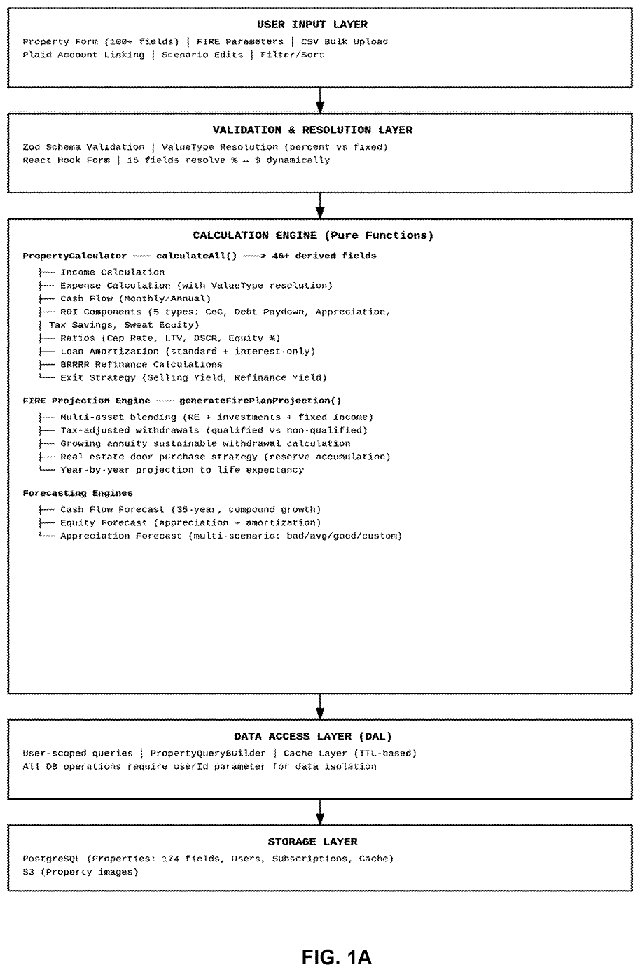

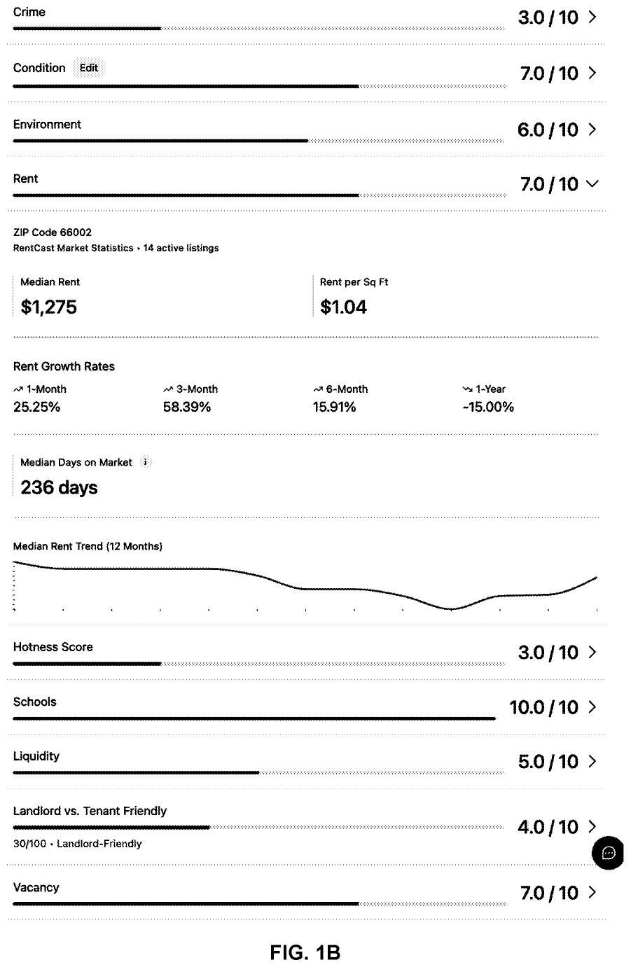

### System Architecture (FIGS. 1a and 1b)

The platform is implemented as a web-based application with a server component and a client component. The server houses the business logic and communicates with external data providers. A relational database stores user accounts, property records, and cached external data. A utility module contains computational engines for property metrics, financial independence projections, and the risk scoring algorithm. The client (e.g., a browser application) renders the user interface, collects user inputs, and fetches data via API requests. This modular design enables the risk scoring logic to operate independently of the presentation layer, facilitates scalability, and supports cross-platform deployment. FIG. 1A shows this architecture as a layered block diagram, and FIG. 1B shows the same architecture organized by module, both illustrating the same disclosed system.

### External Data Acquisition and Caching

Upon receiving a property identification (e.g., an address) from the user, the server geocodes the address to obtain geographic identifiers such as census tract and ZIP code. It then initiates asynchronous API calls to the following data providers:
(1) Crime Data (FBI)—Provides counts of violent and property crimes at tract or state levels. The server normalizes per-capita crime rates using census population data and caches the risk score for ninety (90) days.
(2) Census Bureau—Supplies population growth, vacancy rates, and geocoding information. Data are refreshed quarterly (90 days).
(3) National Risk Index (FEMA)—Supplies hazard scores for flood, wildfire, earthquake, tornado, hurricane, and volcano. The average hazard score is cached for ninety (90) days.
(4) RentCast—Provides median rents, rent growth, and median days on market. Because rent conditions change frequently, the system caches this data for thirty (30) to ninety (90) days.
(5) SchoolDigger—Provides school district ratings (stars and percentile rank). Data are refreshed semi-annually.
(6) Realtor.com—Supplies market hotness and inventory metrics, refreshed daily.
(7) Address Validation (Smarty Streets)—Verifies addresses and provides latitude/longitude coordinates.
(8) Plaid and Other Financial APIs—Retrieve account balances and holdings for integration with financial portfolios.
(9) AI CSV Mapper—Assists with mapping CSV uploads to property fields.

Two factors-property condition and landlord-tenant friendliness-are computed locally based on user input and do not rely on external calls.

Each external data call is proxied through an internal API endpoint. The responses are stored in the database with a field identifying their source and a TTL. When a user views a property's risk tab, the server first checks whether cached data are valid; if not, it fetches fresh data. This caching strategy reduces load on external APIs while ensuring timely updates.

### Risk Factor Calculations

The preferred embodiment uses eleven factors with default weights summing to 100%. Each factor is scored on a 0-10 scale using formulas derived from the raw data. Users may adjust the weights globally or per property.
(1) Crime (weight 30%)—For a given property, the system retrieves violent and property crime counts for the census tract. It computes a combined crime risk score by normalizing per-capita rates relative to national distributions. The score is obtained by dividing the combined risk by 10 and rounding to the nearest integer. If tract-level data are unavailable, state-level data serve as a fallback.
(2) Condition (weight 17%)—The algorithm calculates an age-based score by subtracting the year built from the current year, clamping the result between 0 and 100, and dividing by 1 (so a 100-year-old property scores 100 and a new property scores 0). The user selects a condition category (new, excellent, good, average, fair, poor, or bad), each mapped to a numeric score (e.g., 14 for “new,” 29 for “excellent,” up to 100 for “bad”). The final condition score is a weighted average of the age-based score (e.g., 25%) and the category score (e.g., 75%), then divided by 10 to scale to 0-10. If the user edits the year built or condition, the score updates instantly.
(3) Environmental Risk (weight 15%)-The algorithm obtains hazard scores for flood, wildfire, earthquake, tornado, hurricane, and volcanic activity from the National Risk Index. It averages these normalized hazard scores and divides by 10 to yield a 0-10 environmental score. Users may override this factor if they have installed mitigation measures (e.g., flood barriers).
(4) Rent Market (weight 8%)—The platform computes two sub-scores: rent growth risk and median days-on-market risk. Each sub-score is an adjusted risk score derived from RentCast data. The algorithm calculates combined=(rentGrowthRisk×0.5)+(medianDaysOnMarketRisk×0.5) and sets the rent market score to round(combined/10). High rent growth and short leasing times increase the score.
(5) Market Hotness (weight 7%)—Realtor.com's hotness score (0-100) reflects buyer demand. The algorithm computes a risk score as (100—hotnessScore) and divides by 10 to yield a 0 -10 score. Lower hotness (cold markets) results in higher risk scores.
(6) Schools (weight 5%)—School quality is scored using district star ratings (rankStars) and statewide percentile (rankStatewidePercentage). The algorithm normalizes the star rating to a 0-1 range and the percentile to 0-1, then computes score=round(((1−districtNormalized) ×0.75+(1−percentileNormalized)×0.25)×10). Better schools yield higher scores (i.e., lower risk).
(7) Liquidity (weight 5%)—Liquidity measures how quickly properties sell in the area. The system uses a ranking of median days on market by ZIP code and computes score=round(domZipRanking.adjustedRiskScore/10). Markets with short DOM receive higher scores.
(8) Landlord/Tenant Friendliness (weight 5%)—The system assesses state legal factors such as eviction timelines, rent control, and short-term rental regulations. It computes three sub-factors: landlordFactor=landlordScore/100 (higher scores=more tenant-friendly=higher risk); rankFactor=(51−stateRank)/50 (reverse ranking); and strFactor=1−strScore/5 (short-term rental friendliness). The final score is round((landlordFactor×0.6+rankFactor×0.2+strFactor×0.2)×10).
(9) Vacancy (weight 3%)—The vacancy score is derived from vacancy rates retrieved from the Census Bureau. The algorithm uses a normalized risk score provided by the data source and computes score=round(adjustedRiskScore/10). If the normalized risk is unavailable, the system falls back to a risk comparison with national vacancy statistics.
(10) Population Growth (weight 3%)—The algorithm retrieves the county's one-year population growth ranking and divides the adjusted risk score by 10 to produce a 0-10 score. Faster growth yields higher scores.
(11) Job Growth (weight 2%)—Local employment trends are assessed using labor statistics. The algorithm divides the normalized risk score by 10, so regions with robust job growth receive higher scores.

### Overall Risk Score

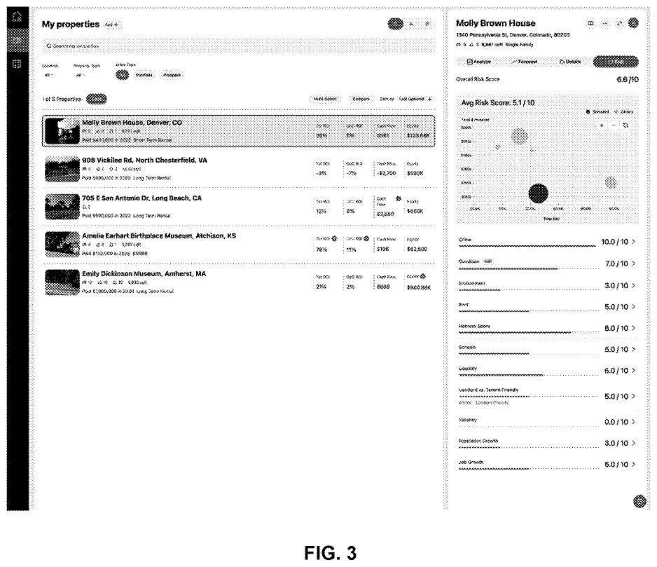

After calculating individual factor scores, the system computes the overall risk score. It initializes weightedSum=0 and totalWeight=0, iterates through each factor where a score is not null, adds (score×weight) to weightedSum, adds weight to totalWeight, then calculates overallScore=round((weightedSum/totalWeight)×10)/10. This yields a score between 0 and 10 with one decimal precision. The result is displayed as a colored bar (e.g., green for low risk, yellow for moderate risk, red for high risk) on the properties dashboard (FIG. 3).

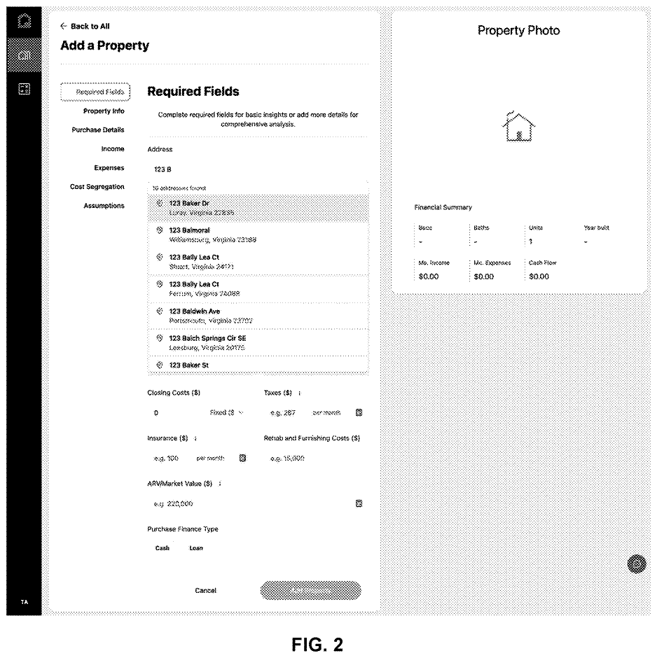

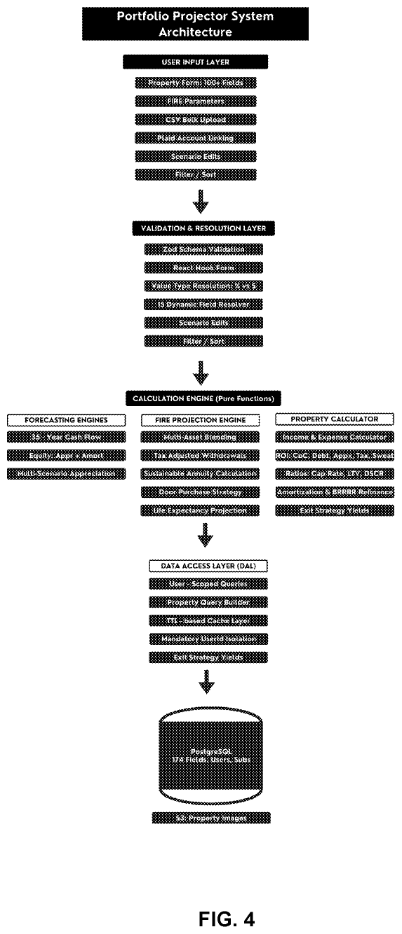

### User Interface and Interaction (FIGS. 2 and 4)

FIG. 2 depicts the property input form. Users provide the address, purchase price, year built, and condition. They may link financial accounts through a secure API to integrate the property with their broader portfolio. After submission, the interface triggers the risk scoring process. The system displays a loading indicator while retrieving external data and progressively fills in each factor card as data arrive.

FIG. 3 shows a dashboard listing multiple properties. Each property entry includes a horizontal bar representing its overall risk score and icons that link to the detailed view. The bars are color coded to allow quick comparison.

FIG. 4 illustrates the detailed property view. The left panel displays the overall score and the weighting breakdown. On the right, collapsible cards show each factor's description, raw data values (e.g., crime counts, rent growth percentage), normalized scores, and formulas. Users can adjust the weight sliders or edit inputs (e.g., condition category, landlord-tenant friendliness). When a user changes a weight, the system immediately recalculates the overall score and updates the visual indicators.

### Portfolio Integration and Unique Advantages

Unlike prior art that treats real-estate risk scoring and financial portfolio management separately, the disclosed system integrates both domains. Users link their checking, savings, and brokerage accounts via secure APIs so that the dashboard displays the value of financial assets alongside property values. The risk scores influence portfolio analytics in several ways:

Risk-adjusted projections: The system's financial independence (FIRE) engine produces 60-year projections of net worth, cash flow, and retirement timelines. Real-estate assets contribute to these projections based on their current value, expected appreciation, and cash flow. The risk score can be used to discount projected returns for high-risk properties or to recommend reserves for vacancies and repairs.

Scenario analysis: Users can clone a property and adjust assumptions (e.g., rent growth, rehab plan) to see how the risk score and financial projections change. The system shows side-by-side comparisons of scenarios, enabling more informed investment decisions.

Alerts and optimization: The system may alert the user when aggregated risk across the portfolio exceeds a threshold or when a single property's risk deteriorates. Future enhancements may incorporate optimization algorithms that suggest acquisitions or dispositions to achieve desired risk/return profiles.

Comprehensive factor coverage: By combining factors such as crime, environmental hazards, school quality, and landlord-tenant laws, the system offers a more nuanced assessment than tools that consider only economic conditions or a small set of indicators.

### Alternative Embodiments

The invention is not limited to the specific factors and weights described above. Alternative embodiments may include additional factors (e.g., access to public transit, proximity to amenities, local GDP growth) or fewer factors depending on the use case. Weights may be derived automatically via machine-learning models trained on historical data. Scoring functions could employ percentile ranks, z-score normalization, geometric means, logarithmic scaling, or other mathematical transformations. The scores may be presented in different visual formats, such as radar plots, heat maps, or letter grades. The platform may be delivered as a mobile application, a desktop application, or an application programming interface (API) for third-party software.

### Advantages Over the Prior Art

Comprehensive factor set: The platform assesses eleven distinct risk factors, including social (crime, school quality), economic (rent growth, job growth), and regulatory (landlord-tenant laws) aspects. Prior systems evaluate fewer factors and omit key local variables.

User customization: Users can modify weights and inputs to reflect their investment goals and local knowledge. This contrasts with rigid weighting schemes that treat all factors equally or use fixed weights.

Intelligent caching: The system caches data with different TTLs based on volatility. This improves performance while ensuring data remain current.

Portfolio integration: Real-estate risk scores are combined with financial account data, enabling holistic portfolio analysis and risk-adjusted projections. Traditional portfolio tools do not incorporate granular property risk.

Scenario analysis and visualization: The platform offers what-if analysis and interactive charts to visualize risk distribution across properties and time horizons.

What is claimed is:

1. A computer-implemented method for generating a real-estate risk score for a property, the method comprising: (a) receiving a property identifier and obtaining geographic information; (b) retrieving data corresponding to a plurality of risk factors from multiple external data sources, the factors comprising at least crime, property condition, environmental hazards, rent market metrics, market hotness, school quality, liquidity, landlord-tenant friendliness, vacancy, population growth, and job growth; (c) for each factor, normalizing the retrieved data into a factor score within a common range; (d) applying a weight to each factor score; (e) accepting user-editable inputs that override or adjust at least one of the factor scores or weights; (f) summing the weighted factor scores to produce an overall risk score for the property; and (g) presenting the overall risk score and factor scores in a graphical user interface.

2. The method of claim 1, wherein the normalizing step in (c) includes calculating an age-based score for the property and combining it with a user-selected condition category to compute the property condition score.

3. The method of claim 1, wherein the normalizing step in (c) for crime comprises dividing a combined violent and property crime risk score by a scaling factor and using state-level data as a fallback when tract-level data are unavailable.

4. The method of claim 1, wherein the normalizing step in (c) for rent market comprises combining a rent growth risk score and a median days-on-market risk score, each weighted by one-half, and dividing the combined value by a scaling factor.

5. The method of claim 1, wherein the normalizing step in (c) for market hotness comprises subtracting a market activity index from a maximum value to compute a risk score and dividing by a scaling factor.

6. The method of claim 1, wherein the normalizing step in (c) for school quality comprises calculating a weighted average of district rating and statewide percentile ranks and scaling the result to the common range.

7. The method of claim 1, further comprising caching the retrieved data in a database with a time-to-live that differs among data sources based on the volatility of the underlying data.

8. The method of claim 1, further comprising aggregating risk scores for a plurality of properties associated with a user and presenting the aggregated risk information alongside financial account data in a portfolio dashboard.

9. The method of claim 8, further comprising generating risk-adjusted financial projections and scenario comparisons using the aggregated risk scores.

10. A system for performing the method of any of claims 1 through 9, comprising one or more servers programmed to execute instructions that perform the method, a database storing property and external data, interfaces to external data providers and financial institutions, and a client application configured to display the risk scores and portfolio information.
